(19) United States
(12) Patent Application Publication
(10) Pub. No.: US 2024/0408759 A1
(43) Pub. Date: Dec. 12, 2024

(54) METHOD, MACHINE CONTROL AND COMPUTER-PROGRAM PRODUCT FOR DETERMINING A PATH FOR AUTONAVIGATION

(71) Applicant: ARBURG GMBH + CO KG, Loßburg (DE)

(72) Inventors: Werner FAULHABER, Loßburg Wittendorf (DE); Jürgen PETERS, Schiltach (DE)

(21) Appl. No.: 18/688,063

(22) PCT Filed: Sep. 1, 2022
(86) PCT No.: PCT/EP2022/074294

§ 371 Date: Feb. 29, 2024

(30) Foreign Application Priority Data
Sep. 1, 2021 (DE) 10 2021 122 606.6

(51) Int. Cl. B25J 9/16; B29C 45/42; B29C 45/76; B29C 45/80

(52) U.S. Cl. CPC B25J 9/1676; B29C 45/42; B29C 45/7626; B29C 45/80; B29C 2045/4275; B29C 2045/7633; B29C 2945/76083; B29C 2945/76317; B29C 2945/76421; B29C 2945/76568; B29C 2945/76899

(57) ABSTRACT

In a method for determining at least part of a path (12) for connecting at least one starting point (14) to at least one finishing point (16) in a space (R) for at least one autonavigation of at least one movable component through the space on a machine (100), at least one model of the movable component and the machine is provided, information on the geometry is gathered, current positions are determined and these are brought into relation with one another to create a graph (10). An algorithm is used to calculate the path (12), collision-free autonavigation along the path (12) being carried out after a collision check has been performed. This assists the operator in adapting the machine cycle, while likewise bringing about an improvement in terms of the travel path, cycle time, reliability of the process, energy and wear.

### REFERENCE TO RELATED APPLICATIONS

The present application relates to and claims the priority of German patent application 10 2021 122 606.6, filed on Sep. 1, 2021, the disclosure of which is hereby expressly, in its entirety, made part of the subject matter of the present application.

### TECHNICAL FIELD

The disclosure relates to a method for determining at least a part of a path for connecting at least one starting point to at least one finishing point in a space for at least one autonavigation, from the starting point to the finishing point, for removing, transferring and/or depositing a molding, of at least one movable component through the space on a machine, which is an injection molding machine for processing plastics and other plasticizable materials or a 3D printing machine, to a machine control, and to a computer-program product.

For the explanation of the disclosure, a number of terms are first defined as follows.

In the context of this application, an “axis” is understood to mean movable parts, for example of machines, systems, system parts and/or peripheral devices, which can be actuated, for example, by means of a drive, for example a motor. For the example of an injection molding machine, an axis would be, for example, the spindle of a spindle system.

In the context of this application, a “machine” is understood to mean at least all the parts that are structurally required for the operation of a machine, such as, on an injection molding machine, the mold closing unit with the injection mold accommodated therein, the injection molding unit, the machine base and the associated drives. At least the region of the space in which the machine or its parts can collide with a movable component, for example a peripheral device, is relevant for autonavigation. A specific case here is, for example, a robot arm with gripper that moves in the mold clamping space between the open mold carriers of the mold closing unit. The robot arm and/or the gripper can perform various movements, such as tilting, swiveling and rotating movements. These movements can change the vector of the robot arm and/or the gripper. The machine can have at least one machine part, such as a tool, a mold cavity, a molding, a sprue, a moving platen, a stationary platen and/or an injection unit. Furthermore, the machine can have other machine parts and/or components. These machine parts can also move and can preferably also be autonavigated in the space using the method presented. The machine part is then preferably autonavigated along a path that was calculated using the algorithm so that there is no collision with other machine parts, movable components and/or the machine.

When reference is made in the following to the machine, this always refers to the machine and, where applicable, the machine parts of the machine.

In the context of this application, a “movable component” is understood to be an element movable relative to the machine, such as a peripheral device. This may be a robot arm, gripper, robot, ejector or other movable components of a peripheral device as well as of the machine, which move in the space so that a collision with the machine is to be avoided, in particular if the machine and/or machine parts also move.

### BACKGROUND

Nowadays, many or all processes in an injection molding process are automated. Not only is the complete control of an injection molding machine usually fully automated, such as the closing of the mold platens, the application of the pressure and the opening of the mold platens, but also the removal, the transfer and/or the depositing of a molding, for example by means of a robot. There are often several axes in the machine space and/or tool space, for example vertical axes, for example of peripheral devices, for example a robot or a robot gripper, so that the axes may interfere with or collide with one another during the injection molding process, for example when removing the molding. For advantageously efficient productivity, the shortest possible cycle time is desirable, which is also determined, for example, by the removal speed of the molding, for example by the peripheral device.

Systems are known in plastics processing machines and systems in which, for example, robot sequences can be created interactively. For example, so-called teach functions can be used to enter or “teach” sequence positions, for example points of a path, and thus automatically enter them into a robot sequence controller, for example (see, for example, WO 2009/080296 A1).

Also known are systems in which envelope-geometry information from the robot and tool is used in the sequence to perform quasi-static collision checks (for example of the robot arm or robot gripper) with the machine at the end points and teach points.

Document DE 10 2012 103 830 A1 discloses a method for preventing mutual blocking of a pair of robots which have a common working area. Each robot is controlled by an associated program. The robots occupy a portion of a common workspace area during simultaneous execution of the programs. An interference area is identified, in which the portions of the common working area overlap. The interference area is analyzed and it is identified where a mutual blocking of the robots can occur. To avoid the blocking, an instruction is executed which avoids at least one condition of mutual blocking during an execution of the programs.

Document DE 690 27 634 T2 discloses a collision detection method for a multi-robot arrangement with at least two elements. For collision detection, the anti-collision problem is split into a collision detection phase and an avoidance (evasive maneuver) phase. By further splitting the 3D collision detection problem into a 2D XY detection and a 1D height comparison, the problem can be further simplified.

To determine time-efficient collision-free paths, EP 1 672 449 A1 provides a machine control with a data set that has a collision parameter 0 or 1 at each discretized coordinate point and for each combination of discretized tool models and workpiece models. The collision parameter indicates whether or not the constellation associated with the corresponding coordinate point, that is to say the relative position of the workpiece and tool, results in a collision or spatial overlap of the tool and workpiece. The data set forms a look-up table that can be used to check given paths or to extend or build paths step by step.

In WO 2009/024783 A1, a computer-implemented method is disclosed for determining a movement between a component and a device interacting with the component. Geometric data relating to the component and the device are received and the geometric data are used to determine how the device and the component can be moved relative to one another, using optimization criteria. In one exemplary embodiment, a model of an object, a turbine blade, is loaded and a surface of the object is selected on which multiple points are generated. The points are then approached by the measuring device in a path-optimized manner.

US 2017/0090454 A1 discloses a method for generating positioning travel data for a CNC machine. Optimized positioning paths are generated on the basis of machine kinematics, machine axis travel limits, machine axis speed and acceleration limits, and machine positioning methods, wherein a plurality of possible paths for repositioning a tool from a first configuration to a second configuration are determined.

DE 10 2004 027 944 A1 discloses a method for protecting at least two robots against collisions, in which movements of a robot are automatically checked for possible collisions and interlocks are automatically inserted in the movement sequence.

The functions described already facilitate the programming of robot sequences and help to avoid errors. However, all of the individual support systems described above have the problem that they are incomplete and, within certain limits, inaccurate. Therefore, interaction with the operator is still necessary during programming. This also means that damage caused by collisions cannot be completely prevented.

The aim is not simply to improve robot sequences by combining the various individual functions described, but to create the conditions for dynamic, collision-free autonavigation by taking a completely new approach.

### BRIEF SUMMARY

The disclosure provides a method for determining at least part of a path for at least one autonavigation, which method supports the operator in making adjustments to the machine cycle and is optimized in respect of travel path, cycle time, reliability of the process, energy and wear.

The method for determining at least a part of a path for connecting at least one starting point to at least one finishing point in a space for at least one autonavigation of at least one movable component, for example of a peripheral device, for example a robot or a robot gripper, through the space on a machine, which is an injection molding machine for processing plastics and other plasticizable materials or a 3D printing machine configured for removing, transferring and/or depositing a molding,, comprises the following steps.

The machine, as defined at the outset, can have at least one machine part, such as a tool, a mold cavity, a molding, a sprue, a moving platen, a stationary platen and/or an injection unit. The machine can also have other machine parts and/or components, of an injection molding machine or a 3D printing machine. The machine parts can move and can preferably also be autonavigated in the space using the method presented. The machine part is then preferably autonavigated along the path that was calculated using the algorithm so that there is no collision with other machine parts, peripheral devices and/or the machine.

When reference is made in the following to the machine, this always refers to the machine and, where applicable, the machine parts of the machine.

A “movable component” is an element movable relative to the machine, such as a peripheral device. Such components can be, for example, grippers, robots, ejectors or other movable components, for example of a peripheral device as well as the machine, which move in the space so that a collision with the machine is to be avoided, especially if the machine also moves.

Firstly, at least one model, for example a digital model of the at least one movable component, for example a peripheral device, and of the machine and of the molding is provided. Depending on whether the machine has machine parts, corresponding models can also preferably be provided for the machine parts. For example, the model can be provided as a file to a computer, a program or a controller. It is also possible that the model is provided by means of a network or is already present on the machine. The model can contain information about the geometry of the movable component and/or the machine. The geometry of the model can be described using geometry models such as Collada.

In a further step, geometry information of the space and the at least one movable component and the machine and the molding is gathered. Depending on whether the machine has machine parts, corresponding geometry information can preferably also be gathered for the machine parts. The geometry information can, for example, be taken from the model or is contained in the model. The position of the moving platen, for example, can also be clearly determined at any time using an actual value of the platen position known to the machine control. This results, for example, in the geometric dimensions in length, width and height of the individual movable components, the machine and, if applicable, the machine parts. Furthermore, it is preferably conceivable to detect the geometry information using sensors.

In a next step, a current position of the at least one movable component and the machine and the molding in the space is determined. Depending on whether the machine has machine parts, a current disposition of the machine parts in the space can preferably also be determined. The disposition refers, for example, to the position and/or the orientation. For example, the disposition of an axis in the space, for example in a Cartesian coordinate system, can be clearly determined with an angle relative to the zero disposition. It is therefore also possible, for example, to detect the orientation of an axis, for example of a robot in the space. Here too, the current disposition can preferably be detected using sensors.

The geometry information and the current disposition of the at least one movable component and of the machine and of the molding in the space are brought into relation with one another, for example by a computer or a machine control, in order to generate at least one graph of the space. Depending on whether the machine has machine parts, the geometry information and the current disposition of the machine parts can preferably also be brought into relation with the geometry information and the current disposition of the at least one movable component and the machine to generate a graph in the space. The geometry information and the current disposition are used to determine the arrangement of movable components, such as peripheral devices, and the machine and, where applicable, the machine parts in the space, so that a “map of the space” can be generated as a graph. The movable components, the machine and, where applicable, the machine parts can be represented in the graph as an obstacle, for example.

In a further step, the path is calculated by applying at least one algorithm to the graph, wherein at least one optimization is additionally performed for calculating the path.

In a further step, at least one collision check is carried out along the path between the at least one movable component, the machine and the molding. Depending on whether the machine has machine parts, the machine parts can preferably also be taken into account in the collision check. For example, a collision between a peripheral device and the machine or machine parts may occur during the removal of the molding. The collision check is carried out along the path, for example, by checking whether there is an obstacle along the path.

The collision check is preferably performed in real time. If the collision check reveals that there is an obstacle along the path, a new calculation of the path is performed, for example, after a movement instruction to the movable component, to the machine and/or, where applicable, to the machine part. If the collision check shows that there is no obstacle along the path, the at least one movable component is autonavigated along the path in a further step, wherein the at least one movable component moves relative to the machine.

During an injection molding process, the movable components such as peripheral devices, the machine and/or, where applicable, the machine parts, such as parts of an injection mold, usually move relative to one another, so that the path for autonavigation must be adapted. For advantageously increased safety and user-friendliness, the algorithm is applied while dynamically changing the graph as a result of movements of the at least one movable component and/or the machine and/or the molding. Depending on whether the machine has machine parts, the algorithm can preferably be applied while dynamically changing the machine parts. If, for example, the movable component, the machine and/or, where applicable, the machine part move in such a way that the graph changes such that there is an obstacle along the current path, the movement of the movable component, the machine and/or, where applicable, the machine part is stopped on the current path with obstacle and continued on a new calculated path. Each movement can therefore change the path on the “map”, which is described by the other existing elements and on which the movable component can be moved. The same also applies to the elements used in a 3D printing process, for example material feed unit, discharge head, fiber feed unit, construction support, object to be produced.

Since unforeseen events may occur during a production process, the method is simulated in real time in the event of a change in the production sequence and the algorithm reacts to changed positions and/or speeds of the at least one movable component, such as a peripheral device, and/or the machine and/or the molding, by performing at least one further collision check and by calculating at least one new path and applying the algorithm again, using a current actual position as the starting point, wherein the calculation, the collision check and the autonavigation are performed predictively. In other words, during a movement it is possible, for example, that an obstacle is located along the path for a certain period of time, but that this obstacle, due to movements of the movable component, the machine, the molding and/or, where applicable, the machine part, disappears from the path again before the movable component, the machine, the molding and/or, where applicable, the machine part encounter the obstacle or collide with it. Advantageously, this means that the direction does not have to be changed, which avoids shocks due to changes in direction, for example. Depending on whether the machine has machine parts, the algorithm can preferably also react to changed positions and/or speeds of the machine parts by carrying out at least one further collision check and/or by calculating at least one new path.

The operator is thus supported in adapting the machine cycle, wherein an improvement results in terms of travel path, cycle time, reliability of the process, energy and wear. The shortest/fastest travel path is also determined with the least possible computing time and memory requirement. Another advantage is a collision-free travel path for which manual programming and parameterization using the machine and/or robot control by the individual carrying out the set-up is not necessary or is largely automated.

In this way, it is advantageously possible to react to changes in the same way as for autonavigation in road traffic, with the difference that, in contrast to road traffic, here the graph, i.e. the map, changes. The stored algorithm is able, for example, to react to changes in actual position values and axis speeds. The operator no longer has to take the robot system into consideration when adjusting the machine cycle, for example. The sequences of the robot system are adapted automatically and dynamically. This can be done during the current cycle, as the high performance of the process means that the current actual position can be used as the new start value and the changed obstacle (for example moving mold half) can be readjusted to determine the optimum path to the finishing point.

This means that the path can be adapted if a parameter change relevant to the autonavigation occurs during the current cycle. For example, the method registers whether there is a change in the graph during the autonavigation, such as a change in obstacles. If there is an obstacle on the path due to the change, the algorithm is applied again based on the current position and a new path is calculated. If the obstacle does not affect the current path, no new calculation is performed.

For advantageously accurate and precise navigation, at least one contact point of at least one movable component and the machine is preferably provided in each case with respect to its position in the space, the contact points being logically coupled to one another for providing the model of the at least one movable component and the machine. Depending on whether the machine has machine parts, at least one contact point of the machine parts can preferably be provided and coupled with other contact points. For example, the injection mold can be clearly described at the attachment surface to the mold by at least one contact point in terms of position and location in the space, supplemented by an angle of the zero disposition, to which, for example, the next machine part and/or a peripheral device can automatically couple. This point is logically linked to the current actual value of the moving platen, for example, and is automatically tracked. This contact point can be referred to as a “socket”, for example, by analogy with electrical engineering. The fixed platen, for example, can also have at least one point in relation to position and location and angle in the space, which is static in the case of the fixed platen.

For example, the geometry of a robot as a movable component can also be known as a model and its position in relation to the machine can be known. In the simplest case, the robot is geometrically and/or logically coupled with its base or foot by means of the “plug” and “socket” function described above, for example with the fixed mold plate of the machine. The robot's vertical axis has a flange plate, for example, to which a molding-specific gripper is coupled. The flange plate can have additional tilting, swivel and/or rotary axes. This means that the logical coupling point, i.e. “socket”, for coupling the gripper follows the travel, tilting, swivel and/or rotational movement of the flange plate. The molding-specific gripper can, for example, be logically connected to the gripper flange by means of its model and by means of a defined coupling point, i.e. “plug”, and can be geometrically tracked by means of any travel, tilting and/or rotational movements. The gripper in turn has at least one coupling point (for example center of the suction cup surface), which in turn can accommodate the molding as a logical “socket”. The position of the gripper in relation to the current path is also relevant. In certain orientations, strong accelerations may cause the molding to slip on the suction cup of the gripper; in extreme cases, the gripper loses the molding. Depending on the gripper orientation, the acceleration can preferably be limited accordingly. In an injection molding process, the mold is opened after the end of the formation of the molding. The target position of the gripper can preferably be determined geometrically for the removal of the molding, wherein all potential collision edges and interfering geometries are known as obstacles.

In order to advantageously obtain a quick and reliable check with regard to couplable models, at least one list is preferably associated with the at least one contact point, on the basis of which list couplable models are described and/or listed. For example, the movable part of an injection mold is coupled to the movable platen. The injection mold is also known as a model and is digitally available in the machine, for example. This part of the digital model of the injection mold (movable mold half) now has a defined coupling point, which is precisely defined in the model in terms of position and location in the space. This point can be called a “plug”, for example, correspondingly. The movable mold half with its contact point “plug” is listed in the coupling list at the “socket”, for example of the movable tool platen. Preferably, by using a “plug” or a “socket”, for example, the movement of a peripheral device and/or a machine part can also be used to track the movement of the peripheral device and/or machine part coupled thereto.

For an advantageously precise calculation of the path, the space is preferably subdivided into a grid of cubes, which is used to generate the at least one graph. Preferably, the entire space is subdivided into a grid of cubes, which is used to generate the at least one graph. The space may at least partially comprise the at least one movable component and/or the machine. Depending on whether the machine has machine parts, the space may preferably also contain at least some of the machine parts. In the graph, for example, the movable component, the machine and/or, where applicable, the machine parts are then shown as an obstacle. The other parts of the space without obstacles can preferably be represented graphically differently as travel regions, for example with different colors.

It is also preferable that a diagonal path can be described independently of the grid size of the space, which for example is divided into cubes. For example, a diagonal can be traversed using a path movement with, for example, two axes and with a defined common path speed. In this case, it is advantageous not to execute several individual movements, but preferably one movement from the starting point to the finishing point, with the axes moving synchronously relative to one another.

Preferably, at least one Greedy Search, a Dijkstra and/or an A* algorithm with at least one open list is used as the algorithm. Depending on the graph, this results advantageously in the shortest path from a starting point to a finishing point.

For an advantageously fast calculation of the path, at least a jump point search and/or open list management is preferably used as an optimization.

For an advantageously optimized management of the open list, the open list is preferably managed with a binary heap.

For an advantageous overview and improved safety, the method is preferably simulated in advance. For example, the sequences and path creation can be simulated in advance on a computer model, which can then be visualized, further advantageously.

To ensure an advantageous improvement in terms of computing time and speed of the method, at least two different variants of the method are preferably simulated and compared with one another in relation to different criteria. The sequence can thus be created in relation to the current tool data set. It is possible here to simulate different variants and compare them in respect of different criteria, for example energy, wear, travel path and/or cycle time.

In order to be able advantageously to remotely monitor the production process, the graph and/or the model of the at least one movable component and/or the machine is preferably displayed graphically. Depending on whether the machine has machine parts, the machine parts can preferably be displayed graphically.

The method described can be carried out with several tools, for example, on an injection molding machine on a multi-cavity tool and/or a multi-component tool that is not mounted directly on the moving platen, but on a rotary unit, for example, which in turn is stored as a model of which the position is precisely defined by means of “plug” and “socket”. A multi-component tool can also be used, in which a preliminary molding is transferred by means of a robot system. It is also possible to use insert parts that are inserted by means of the robot system using a gripper. A cube tool (“cube”) can also be used, which still has at least one axis of rotation and several insertion or removal surfaces, as well as its special form (“reverse cube”), in which the cube is divided again and rotates in the opposite direction. Each half of the cube is described separately here.

The disclosure provides also a machine control for a machine, which is an injection molding machine for processing plastics and other plasticizable materials or a 3D printing machine. For an advantageous adaptation of the machine cycle by the operator as well as for improvements in terms of travel path, cycle time, reliability of the process, energy and wear, the machine control is configured, set up and/or constructed to carry out the method described above.

The disclosure provides also a computer-program product. For advantages with regard to a calculation of the path in terms of travel path, cycle time, reliability of the process, energy and wear, the computer-program product is stored with a program point on a computer-readable medium for carrying out the method described above.

Further advantages can be found in the dependent claims and the following description of a preferred exemplary embodiment. The features listed individually in the claims can be combined with one another in a technically feasible way and can be supplemented by explanatory facts from the description and by details from the Figures, in which further variants of the disclosure are shown.

### BRIEF DESCRIPTION OF THE FIGURES

In the following, the disclosure is explained in greater detail with reference to an exemplary embodiment shown in the appended Figures, in which:

FIG. 1 shows a machine with a movable component,

FIG. 2 shows a machine with a movable component,

FIG. 3 shows a graph after running a Greedy Search search procedure,

FIG. 4 shows a graph after running a Dijkstra algorithm,

FIG. 5 shows a flow chart of the A* algorithm,

FIG. 6 shows a graph after running an A* algorithm,

FIG. 7a, 7b show a comparison of symmetrical paths versus a jump point search,

FIG. 8a-8c shows a comparison to reduce the neighboring number,

FIG. 9 shows a graph after running the jump point search,

FIG. 10 shows a representation of a binary heap in an array,

FIG. 11 shows a graph with a path movement.

### DETAILED DESCRIPTION

The disclosure will now be explained in greater detail by way of example with reference to the appended drawings. However, the embodiments are merely examples and are not intended to limit the inventive concept to a particular arrangement. Before the disclosure is described in detail, it should be noted that it is not limited to the respective components of the device and the respective method steps, as these components and methods may vary. The terms used herein are merely intended to describe particular embodiments and are not used in a limiting manner. Furthermore, when the singular or indefinite articles are used in the description or in the claims, this also refers to the plural of these elements, unless the overall context clearly indicates otherwise.

In one exemplary embodiment, in a method for determining at least part of a path 12 for connecting at least one starting point 14 with at least one finishing point 16 in a space R for at least one autonavigation of at least one movable component such as a peripheral device through the space on a machine 100, which is an injection molding machine for processing plastics and other plasticizable materials or a 3D printing machine, configured for removing, transferring and/or depositing a molding, at least one model of the at least one movable component and the machine 100 and the molding 122 is provided in a first step. The model can, for example, be provided as a digital model.

The machine 100 may have at least one machine part, such as a mold, a mold cavity, a molding, a sprue, a moving platen 110, a stationary platen 112, and/or an injection unit. Further, the machine may have other machine parts and/or components from an injection molding machine or a 3D printing machine. The machine parts can also move, such as the movable platen 110, for example.

Depending on whether the machine has machine parts, a model of the machine part can preferably be provided.

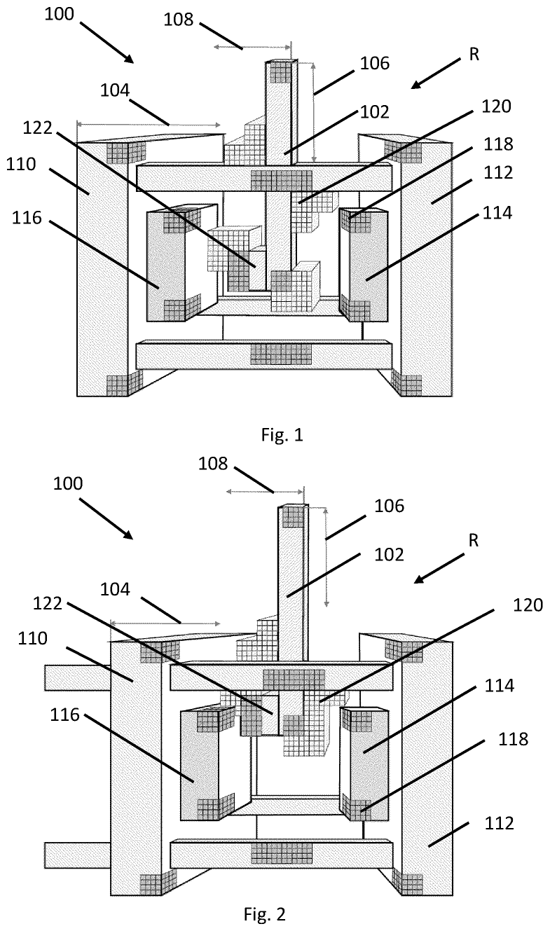

A “movable component” is understood to be an element that is movable relative to the machine, such as a peripheral device. These components can be constituted by grippers, robots, ejectors or other movable components of a peripheral device as well as of the machine, which move in the space R so that a collision with the machine is to be avoided, in particular if the machine also moves. FIGS. 1 and 2 show a vertical axis 102 as an example of a movable component.

In a further step, geometry information of the space R and of the at least one movable component and the machine 100 is gathered. The geometry information can be derived here at least partially from the model or models. For example, the geometry information can also be gathered by means of sensors.

Depending on whether the machine 100 has machine parts, geometry information of the machine part can preferably be gathered.

Furthermore, in a further step, a current disposition of the at least one movable component and the machine 100 and the molding 122 in the space R is determined. The current disposition can, for example, be detected by means of sensors or by means of actual position values of the at least one movable component and/or the machine.

Depending on whether the machine has 100 machine parts, a current disposition of the machine part or parts can be preferably determined.

In a further step, the geometry information and the current disposition of the at least one movable component and the machine 100 in the space R are brought into relation with one another to generate at least one graph 10 of the space R.

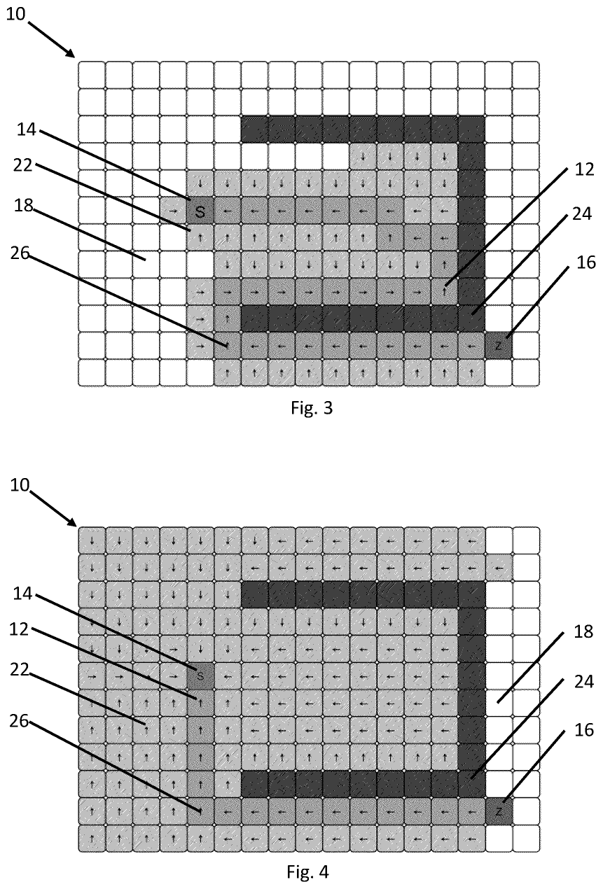

Depending on whether the machine has machine parts, the geometry information and the current disposition of the machine part can preferably also be used to generate the graph 10. For example, this results in a graph 10 as shown in FIG. 3, in which, for example, the machine 100, movable components and existing machine parts are shown as obstacles 24. For the sake of simplicity, the graph 10 in FIG. 3 is shown merely as a two-dimensional graph. In principle, however, the graph can be represented for other and/or several dimensions, for example as a one-dimensional or three-dimensional graph.

The path 12 is calculated by applying at least one algorithm to the graph 10 in a further step, wherein at least one optimization is additionally performed for the calculation of the path 12.

In a further step, at least one collision check is carried out along the path 12. Preferably, the collision check is performed in real time.

Then, in a further step, the at least one movable component is autonavigated along the path 12.

Preferably, a calculation of a path and an autonavigation along the path can also be performed for machine parts of the machine 100. For example, in addition to autonavigation of the movable component, for example the peripheral device, autonavigation of one or more machine parts can also be performed.

In the exemplary embodiment, the algorithm is applied under dynamic change of the graph 10 as a result of movements of the at least one movable component and/or the machine 100 and/or the molding 122. Depending on whether the machine comprises machine parts, the algorithm may preferably be applied under dynamic change of the graph 10 as a result of movements of the at least one machine part. For example, during autonavigation, other machine parts, movable components and/or the machine may also move relative to one another. Due to this movement, the graph 10, i.e. the “map”, may change and thus an obstacle 118 may appear on the already calculated path 12. The algorithm recognizes this change to the graph 10 automatically and registers whether there is an obstacle on the path 12. If this is the case, the algorithm is applied again, wherein the current actual position is now used as the starting point 14. In this way, the path 12 can be adapted in the current cycle if a parameter change relevant to the autonavigation occurs.

In the exemplary embodiment of FIG. 1, a machine 100 is shown having a movable component, for example a vertical axis 102 as a movable component, which is currently removing a molding 122. The vertical axis 102 is intended to remove the molding 122 in a collision-free, autonavigated manner and can be moved in various directions 106, 108, in the exemplary embodiment according to FIG. 1 to the left, right, up and down. In principle, it is conceivable that the vertical axis 102 can also preferably perform a tilting, swiveling and rotating movement and can thus assume any position in the space. This results in any number of vectors that the vertical axis 102 can have.

The machine 100 further comprises a closing unit with a movable platen 110 and a stationary platen 112, which clamp between them a mold clamping space for receiving molds having two mold halves 114, 116. The movable platen 110 can be moved in a direction 104, in the exemplary embodiment according to FIG. 1 to the left and right. In principle, it is also conceivable that the stationary plate 112 can be moved in a direction, for example in the direction 104. The movement of the movable plate 110 also causes the tool half 116 to move. The space R in which the machine 100 is located thus has obstacles 118 and travel regions 120 in which collision-free autonavigation is not possible or is possible, respectively.

FIG. 2 shows a movement of the vertical axis 102 as a movable component and the movable mold plate 110. The vertical axis 102 was moved there with the molding 122 upwards along the direction 106. The movable plate 110 has been moved to the right along the direction 104. The movements correspondingly create new obstacles 118 and travel regions 120 for autonavigation.

The calculation, the collision check and/or the autonavigation is performed predictively. For example, an obstacle 118 only appears along the path for a certain period of time, but it has already disappeared from the path again before the movable component, the machine 100, the molding and/or, where applicable, the machine part would collide with it. Advantageously, this means that the direction does not have to be changed, which avoids shocks due to changes in direction, for example.

In a further preferred exemplary embodiment, at least one contact point of each of the at least one movable component and the machine 100 is provided with respect to a position of the at least one contact point in the space R, wherein the contact points are logically coupled to one another for providing the model of the at least one movable component and the machine. Depending on whether the machine has machine parts, a contact point of the machine part or machine parts can preferably be provided in each case, which can be logically coupled with other contact points. For example, the movable part of an injection mold can be coupled to the movable platen 110. The injection mold is also known and available as a model. For example, the movable part of the model of the injection mold (movable tool half 116) has a defined contact point, which is precisely defined in terms of position and location in the space R in the model. This point can be referred to as a “plug”.

In a further preferred exemplary embodiment, at least one list is associated with the at least one contact point, on the basis of which couplable models are described and/or listed. To remain, in the above example, with the movable tool half 116, this is listed with its contact point “plug” in the list at the “socket” of the movable platen 110.

In a further preferred exemplary embodiment according to FIG. 3, the space R is divided into a grid of cubes 18, which is used to generate the at least one graph 10. The space R may at least partially comprise the at least one movable component and/or the machine 100. Depending on whether the machine comprises machine parts, the space may preferably at least partially comprise a machine part, which is shown as an obstacle 24 in the graph 10 according to FIG. 3, for example. In FIG. 3, for the sake of simplicity, only one plane of the space with obstacles 24 is shown as a graph 10. However, the graph can in principle be three-dimensional.

In a further preferred exemplary embodiment, at least one Greedy Search algorithm, a Dijkstra algorithm and/or an A* algorithm with at least one open list is used as the algorithm.

The following shows how paths 12 between any two points 14, 16 in a graph 10 are calculated. Shortest-path problems are often found in the field of artificial intelligence and are usually associated with a fairly high level of complexity with the aim of finding the best possible path 12 through a graph 10. Path finding deals with the problem of finding a path 12 in a graph 10 from a starting point 14 to a finishing point 16. For the approaches presented, the graph 10 must fulfill the property that all edges of the graph 10 are positively weighted. For this purpose, the machine space is divided into a grid of cubes 18, which are also called nodes 18. Based on the grid-shaped model of the space R, which is used as the graph 10, the shortest possible path 12 from the starting point 14 to the finishing point 16 is sought. In addition, the search graph 10 is only implicit. It must therefore be checked for each node 18 when it is entered whether this node 18 is a valid position of the robot system or represents an obstacle 24.

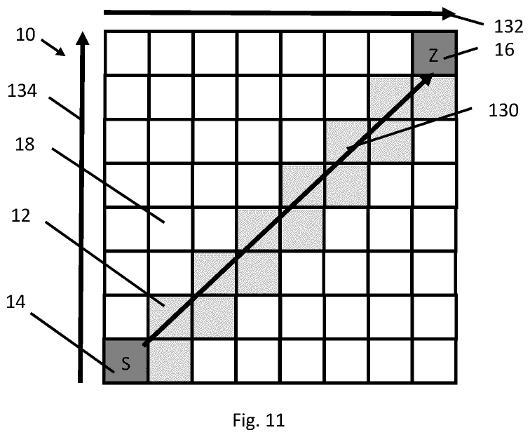

The Greedy Search algorithm is an informed search method and requires an estimation function (heuristic). This estimates the distance from any node 18 to the finishing point 16. For example, it is conceivable that a robot should move one axis after the other. Therefore, the Manhattan distance, for example, can be used as the heuristic function. However, the robot cannot only move linearly in the X, Y or Z direction or cannot only move one axis after the other. Regardless of the grid size, a diagonal path can also be described using cubes, for example. In principle, in a further preferred exemplary embodiment, it is also possible for the robot to follow a diagonal path (FIG. 11) by means of a path movement 130 with, for example, two axes 132, 134 (for example Y and Z) at a defined common path speed. In the case shown in FIG. 11, for example, the robot does not perform 14 individual movements, but one movement from the starting point 14 to the finishing point 16, with both axes moving synchronously with one another.

The search begins at the starting point 14, which is expanded. During expansion, all nodes 18 that can be reached from the starting point 14 are examined for their estimated distance to the finishing point 16 using the heuristics. In addition, a reference to the node 18 that is currently being expanded is stored in each node 22 visited (see arrows 26 in FIG. 3). Thus, each visited node 22 knows its predecessor. The node with the best heuristic is expanded next. The most favorable node is expanded iteratively until the finishing point 16 is found. The node 18 that promises the best result at the time of selection is therefore always selected as the next node. Once decisions have been made, they are not analyzed or revised from a global perspective.

Once the finishing point 16 has been found, the path 12 from the finishing point 16 to the starting point 14 can simply be traced by means of the stored predecessors of the nodes 18. This path 12 is, in reverse order, the searched path 12 from starting point 14 to finishing point 16. One advantage of the Greedy Search algorithm is that it is easy to configure and efficient to implement. It solves problems quickly, but not always optimally. FIG. 3 shows an example where the path 12 found is not always the shortest. For this reason, the Greedy Search algorithm is not always suitable for finding the shortest path 12.

In contrast to the Greedy Search algorithm, Dijkstra's algorithm as shown in FIG. 4 solves the problem of the shortest path. Instead of using an estimating heuristic, Dijkstra takes the opposite approach. The Dijkstra algorithm stores the cost of the path from the visited nodes 18 to the starting point 14. In addition, each visited node 18 also remembers its predecessor node. Beginning at the starting point 14, the node 18 with the lowest traveled path costs to date is expanded iteratively. When expanding, the costs to the starting point 14 are determined for all direct neighbors of the current node 18. This is very simple in this case. As all nodes 18 in the grid are the same size, a cost of “1” can always be estimated for entering a node. The cost therefore results from the number of nodes 22 visited between the starting point 14 and the position under inspection. For this reason, the entire area around starting point 14 is explored evenly. Since each node 18 knows its predecessor, the shortest path from each node 18 to the starting point 14 is known. When the finishing point 16 is found by the uniform expansion, the algorithm terminates, as the path 12 found is already the most favorable. The path 12 must also be processed in reverse order here. This can be comprehended by selecting any visited node 22 in FIG. 4 and following the arrows 26 to the starting point 14.

FIG. 4 clearly shows that although the Dijkstra algorithm finds the shortest path 12 compared to the Greedy Search algorithm (FIG. 3), it has to examine significantly more nodes 18 to do so. This is because it cannot use the information about the position of the finishing point 16 in the graph 10 when selecting the nodes 18 to be expanded. The algorithm can show its strengths above all in scenarios in which the position of the finishing point 16 is unknown. However, if the position of the finishing point 16 is known, an unnecessarily large number of nodes 18 are expanded in most cases. This is at the expense of runtime and memory consumption.

In the field of artificial intelligence, the A* algorithm is a proven approach for calculating the best path 12 between the starting point 14 and the finishing point 16 in a directed graph 10. The A* algorithm combines the advantages of the Dijkstra algorithm and the Greedy Search algorithm and largely eliminates the disadvantages. If a path 12 is found, it is always optimal. In most cases, the number of visited nodes 22 is significantly lower than with the Dijkstra algorithm (FIG. 6). In the worst case, however, it is the same. For each visited node Ki from the path 12, the estimated path costs F are calculated for the entire path 12 from the starting point 14 to the finishing point 16.

To determine the path costs F, the following formula applies: F=G+H. G represents the cost of the path 12 already traveled from the starting point 14 to the node Ki. To determine G, the costs for visiting a node 18 are added to the G of the predecessor. H stands for heuristic, that is to say the estimated costs that will be incurred from node Ki to the finishing point 16. As with the Greedy Search algorithm, a heuristic function is used for this. This must always be adapted to the specific problem. The guarantee of the most favorable path 12 is only given if the heuristic function is underestimating. In other words, it must never estimate higher costs than are actually incurred. The more accurate the estimation function is, the faster the A* algorithm runs. Here too, it is conceivable, for example, that a robot should move one axis after the other. As with the Greedy Search algorithm, for example, the Manhattan distance can then be used as a heuristic function. In principle, however, the robot cannot only move linearly in the X, Y or Z direction or cannot only move one axis after the other. Regardless of the grid size, a diagonal path can also be described using cubes, for example. In principle, in a further preferred exemplary embodiment, it is also possible for the robot to travel along a diagonal by means of a path movement 130 with, for example, two axes 132, 134 (for example Y and Z), with a defined common path speed (FIG. 11). In the case shown in FIG. 11, the robot does not perform 14 individual movements, but one movement from the starting point 14 to the finishing point 16, with both axes moving synchronously with one another. Furthermore, the A* algorithm uses an open and a closed list. The visited nodes 18 are placed in the open list and all fully inspected nodes 18 are placed in the closed list.

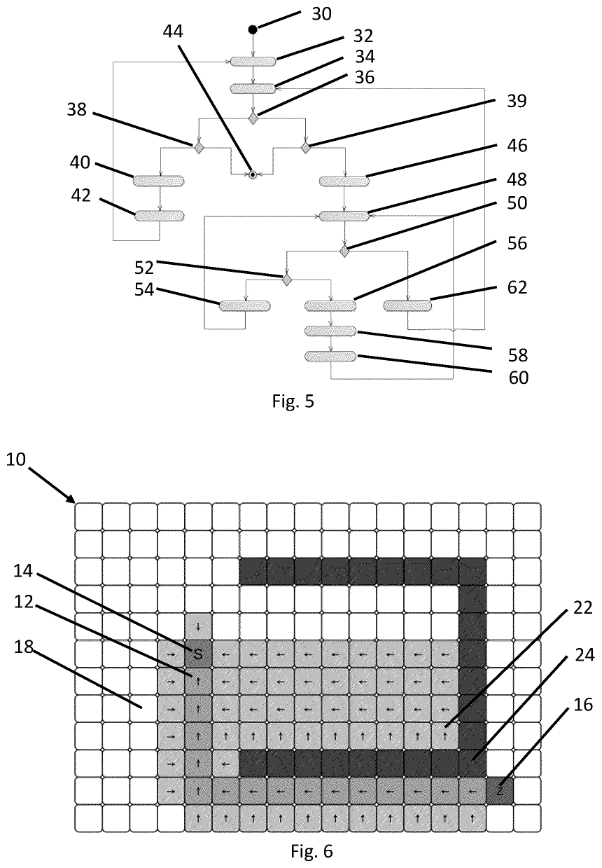

FIG. 5 uses a flow chart to explain the sequence of the A* algorithm. At the start 30, the starting point 14 or the starting node is placed in the open list in step 32, then in step 34 the node 18 with the most favorable F-value is always retrieved from the open list in a loop 36 and processed. If the open list is empty, this means that the algorithm has not found a solution. Since, for example, the robot can change its geometry with the help of rotation axes, the search does not have to be abandoned here.

A further loop 38 checks whether there are, for example, rotation axes that have not yet been actuated. If these can be moved in a step 40, the search starts again in a further step 42. Otherwise, the algorithm comes to an end 44. The search ends successfully when the finishing point 16 is found in a loop 39. If a node 18 is to be processed in step 46, it is checked in step 48 in loops 50, 52 for each of its direct neighbors whether these represent obstacles 24 or are already in the closed list. If yes, the neighbor is ignored in a step 54. Otherwise, the G and H values are determined for the neighbor in a step 56 and the current node is stored as a predecessor in a step 58. Lastly, the neighbor is added to the open list in step 60. Once all of the neighbors of a node have been examined, the node is added to the closed list in a step 62.

As soon as a node 18 has been inserted in the closed list, the most favorable path from this node 18 is known. In the worst case, the A* algorithm must visit all nodes 18. Obstacles 24 on the ideal line impair the runtime immensely, as the costs increase along the obstacle 24 and therefore many nodes 18 in the wrong direction have to be examined first.

In a further preferred exemplary embodiment, at least one jump point search and/or open list management is used as an optimization.

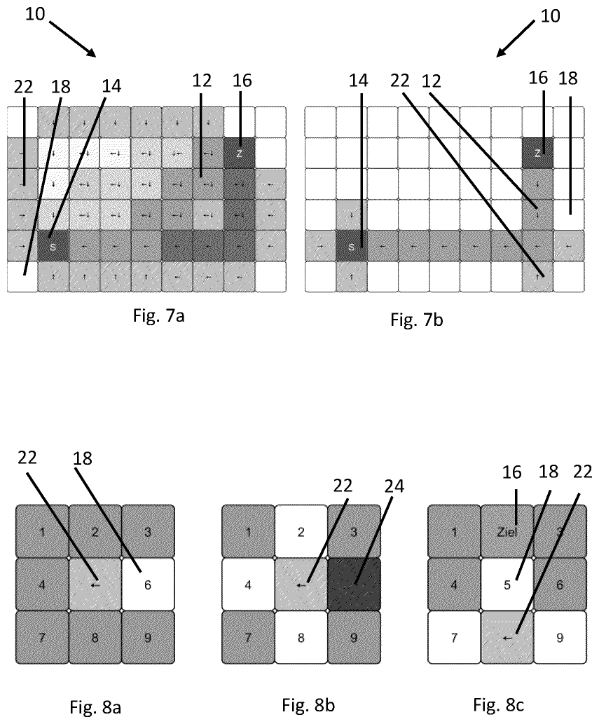

A closer look at the search graph after running the A* algorithm in FIG. 7a reveals that there are a large number of paths 12 with the same costs. This phenomenon occurs in graphs 10 arranged in grid form that only allow horizontal or vertical paths. These paths 12 are said to be symmetrical because they only differ in the order of the movements. For the graph 10 in FIG. 7a and FIG. 7b, this means, for example, that the robot moves a total of six nodes 18 to the right and three nodes 18 upward. The order of the actions is irrelevant. By taking this property into account, the number of nodes 18 visited can be significantly reduced.

In order to achieve a result as shown in FIG. 7b, the symmetry of the paths 12 must be taken into account. The way to success is to reduce the neighbors (Neighbor Pruning). In contrast to the A* algorithm, not all neighboring nodes are always examined when expanding a node 18, but in most cases only one (instead of four in two-dimensional space and six in three-dimensional space). The three most important rules for this can be derived from FIGS. 8a-8c.

### 1^{st} Rule

All neighbors that are not exactly in the direction of movement are ignored. In the example in FIG. 8a, node number 6 is the only node that is placed in the open list. The nodes with the numbers 2, 4 and 8 are not inspected.

### 2^{nd} Rule

If the current node 18 is adjacent to an obstacle 24, all navigable neighbors are examined as in the A* algorithm (FIG. 8b). This is necessary in order to ideally avoid obstacles 24 and find the shortest path 12.

### 3^{rd} Rule

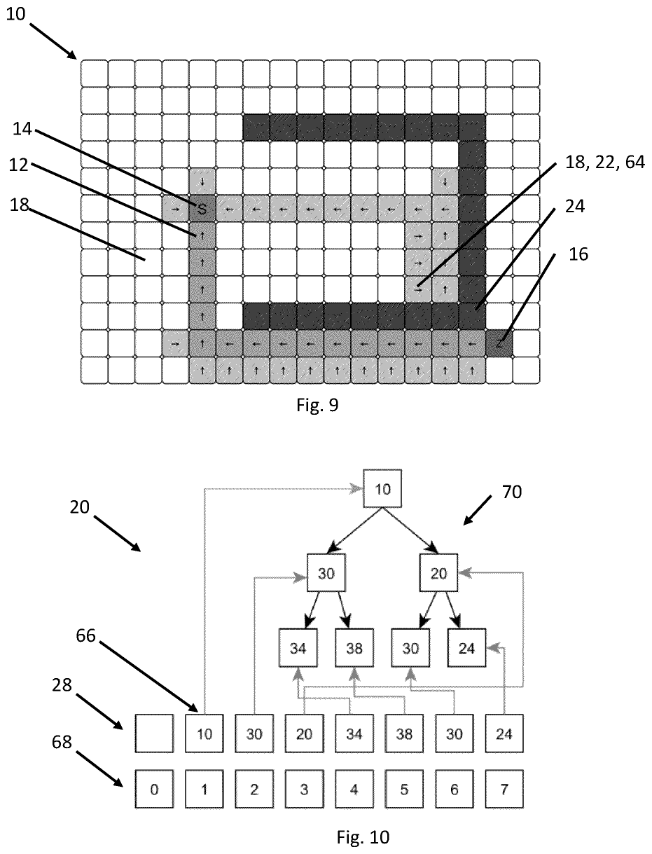

If the neighbor selected in rule 1 has a worse F value than the current node 18, all navigable neighbors are examined (FIG. 8c). This prevents the path 12 from missing the destination in one dimension (FIG. 9).

While rule 1 describes the omission of neighbors, rules 2 and 3 ensure that the search continues to deliver an optimal result. These find the so-called jump points 64, which give the jump point search its name. These points are called jump points 64 because it is possible to navigate between them very quickly and only in a straight line. Jump points 64 can be recognized by the fact that they inspect more than one neighbor. In FIG. 9, for example, node 18, where the path 12 changes direction to the right, is a jump point 64.

The advantages of the jump point search are as follows:
1. It is optimal (finds the most favorable path 12).
2. Pre-calculations are not required.
3. No additional consumption of memory is caused.
4. Significantly speeds up the simple A* algorithm. The following applies here: the longer the path 12, the greater the improvement.

A direct comparison with obstacles 24 between the simple A* algorithm (FIG. 6) and the optimized A* algorithm with a jump point search (FIG. 9) clearly shows once again how many node inspections can be saved with the optimization.

A large part of the computing time for the A* algorithm is spent searching the open list for the element with the lowest F value. The larger the graph 10, the higher the proportion of runtime required to manage the open list. As the graph 10 of the machine space, for example, is very large, it is worth optimizing the management of the open list. In the simplest case, all elements of the open list are kept in an array list. This enables fast insertion (complexity: O(1)) into the list, but slows down the conceivable removal of an element, as each element must be searched to find the smallest F (complexity: O(n)). With a long open list, this can quickly become problematic. One way to easily speed up the removal of elements is to keep the open list sorted. The costs incurred during insertion are only a fraction of what would otherwise be required for removal, especially for larger lists. If a sorting algorithm with a complexity<O(n) is selected for insertion, the effort is worthwhile. The complexity of the removal operation in a sorted list is O(1).

In another preferred exemplary embodiment, the open list is managed using a binary heap 20. Data can be stored very effectively in a structured manner in a binary heap 20. This can be stored in a simple array, for example. Insertion, deletion and search operations can be performed with a worst-case runtime of O(log n), the search for the smallest element 66 (used in the A* algorithm) even with O(1). However, after accessing the smallest element, this must also be deleted. Unlike in a sorted list, a binary heap 20 is not sorted strictly in descending or ascending order. It is a binary tree 70 that fulfills two additional conditions:
1. The binary tree 70 is left-balanced.
2. The following applies for each node 18: The own key is smaller than the key of the child nodes.

This means that the smallest element 66 is always in the first position of the binary tree 70. FIG. 10 shows an example of a binary heap 20. It is noticeable that no element 66 is in the zero-th position in the array 28. This simplifies calculations of the indices of child or parent nodes.

In a further preferred exemplary embodiment, the method is simulated in real time in the event of a change in the production sequence and/or the algorithm reacts to changed positions and/or speeds of the at least one movable component and/or the machine 100 by performing at least one further collision check and/or calculating at least one new path 12. Depending on whether the machine has machine parts, the algorithm can preferably react to changed positions and/or speeds of at least one machine part.

In another preferred exemplary embodiment, the method is simulated in advance. For example, the processes and path creation can be simulated in advance using a computer model.

In a further exemplary embodiment, at least two different variants of the method are simulated and compared with one another with regard to different criteria. For example, different criteria of the method can be compared with regard to, for example, energy, wear, travel path and/or cycle time and the desired favorable method can be selected. For example, the cycle time is of secondary importance for certain processes, while wear is very important or must be taken into account, as the tool or mold, for example, is subject to high stress.

For better clarity, in a further exemplary embodiment, the graph and/or the model of the at least one movable component and/or the machine 100 and/or the molding 122 is represented graphically. Depending on whether the machine has machine parts, the machine part can preferably also be represented graphically. For example, the representation can be made on a machine controller, a screen or a computer.

In one exemplary embodiment, a machine control is disclosed for a machine 100, which is an injection molding machine for processing plastics and other plasticizable materials or a 3D printing machine, which is configured, set up and/or constructed to carry out at least one of the methods described above while achieving the aforementioned advantages.

A further exemplary embodiment is a computer-program product comprising a program code stored on a computer-readable medium for performing at least one of the methods described above while achieving the aforementioned advantages.

It goes without saying that this description may be subject to a wide range of modifications, changes and adaptations that are within the scope of equivalents to the appended claims.

1.-11. (canceled)

12. A method for determining at least part of a path for connecting at least one starting point to at least one finishing point in a space for at least one autonavigation of at least one movable component through the space on a machine, which is an injection molding machine for processing plastics and other plasticizable materials or a 3D printing machine, configured for at least one of removing or transferring or depositing a molding, comprising the steps of:
a) providing at least one model of the at least one movable component and the machine and the molding,
b) gathering geometry information of the space and the at least one movable component and the machine and the molding,
c) determining a current position of the at least one movable component and the machine and the molding in the space,
d) bringing the geometry information and the current position of the at least one movable component and of the machine and of the molding in the space into relation with one another to generate at least one graph of the space,
e) calculating the path by applying at least one algorithm to the graph, wherein at least one optimization is additionally carried out for calculating the path,
f) performing at least one collision check along the path between
1. the at least one movable component,
2. the machine and
3. the molding,
g) autonavigating in collision-free manner the at least one movable component along the path,
wherein the at least one movable component moves relative to the machine and the algorithm is applied while dynamically changing the graph as a result of movements of at least one of the at least one movable component or the machine or the molding,
wherein the method is simulated in real time in the event of a change in the production sequence and the algorithm reacts to at least one of changed positions or changed speeds of at least one of the at least one movable component or the machine or the molding by carrying out at least one further collision check and by calculating at least one new path and applying the algorithm again, using a current actual position as the starting point,
wherein the calculation, collision check and autonavigation are performed predictively.

13. The method in accordance with claim 12, further comprising providing at least one contact point each of the at least one movable component and the machine with respect to a position of the at least one contact point in the space, wherein the contact points are logically coupled to one another for providing the model of the at least one movable component and the machine.

14. The method in accordance with claim 13, wherein at least one list is associated with the at least one contact point, on the basis of which list couplable models are described or listed.

15. The method in accordance with claim 12, wherein the space is divided into a grid of cubes which is used for generating the at least one graph.

16. The method in accordance with claim 12, wherein at least one of Greedy Search or Dijkstra or A* algorithm with at least one open list is used as the algorithm.

17. The method in accordance with claim 16, wherein at least one of at least one jump point search or at least one open list management is used as an optimization.

18. The method in accordance with claim 17, wherein the open list is managed with a binary heap.

19. The method in accordance with claim 12, wherein the method is simulated in advance.

20. The method in accordance with claim 12, wherein at least two different variants of the method are simulated and compared with one another with respect to different criteria.

21. The method in accordance with claim 12, wherein at least one of the graph or the model of at least one of the at least one movable component or the machine or the molding is represented graphically.

22. A machine control for a machine, which is an injection molding machine for processing plastics and other plasticizable materials or a 3D printing machine, wherein the machine control is configured, set up or constructed to carry out the method in accordance with claim 12.

23. A computer-program product comprising a program code stored on a computer-readable medium for carrying out a method in accordance with claim 12.
